(19) United States
(12) Patent Application Publication
(10) Pub. No.: US 2026/0283364 A1
(43) Pub. Date: Sep. 24, 2026

(54) ADJUSTABLE PERSONAL SUPPORT APPARATUS

(71) Applicant: Y.S FODOR LTD, Bnei Brak (IL)

(72) Inventor: Yaakov Yoel FODOR, Bnei Brak (IL)

(21) Appl. No.: 19/690,548

(22) Filed: May 28, 2026

Related U.S. Application Data
(63) Continuation-in-part of application No. 19/484,659, filed on Jul. 29, 2025.

(30) Foreign Application Priority Data
Aug. 26, 2024 (IL) 315263

(51) Int. Cl. A47C 16/00; A47C 7/38; F16M 11/04; F16M 11/20; F16M 13/02

(52) U.S. Cl. CPC A47C 16/00; A47C 7/383; F16M 11/048; F16M 11/2021; F16M 13/022

(57) ABSTRACT

A highly versatile personal support apparatus, such as a travel pillow, provides multi-posture and multi-environment ergonomic support. The apparatus comprises a support member configured to comfortably engage a user's body, a surface engagement member, and an adjustable angular positioning element interconnecting the two. The surface engagement member, such as a vacuum suction cup, removably secures the apparatus directly to smooth, continuous surfaces without requiring structural edges or clamping. The adjustable angular positioning element allows the user to independently adjust and lock the angular tilt and displacement of the support member relative to the anchoring surface. This synergistic combination enables a user to selectively deploy the apparatus across various environments, such as vehicles or offices, and precisely configure it for multiple distinct resting postures, including forward-leaning, backward-reclining, and lateral support, adapting dynamically to the user's specific biomechanical needs.

### CROSS-REFERENCE TO RELATED APPLICATIONS

This application is a Continuation-in-Part of U.S. patent application Ser. No. 19/484,659, filed Nov. 14, 2025, which is a National Phase of PCT Patent Application No. PCT/IL 2025/050654, filed Jul. 29, 2025, which claims the benefit of priority of Israel Patent Application No. 315263, filed Aug. 26, 2024. The contents of all of the aforementioned applications are hereby incorporated by reference in their entirety.

### BACKGROUND OF THE INVENTION

Every now and then, during travel by vehicle, be it a car, bus, airplane or other transportation mean, the traveler may feel tired and may wish to rest their head for support. Often, this involves leaning against a nearby object, like a window, the seat itself, or a chair in front. However, these support options typically fail to provide the desired comfort, leading to discomfort, and occasionally, even causing neck pain. This issue becomes particularly critical when the individual traveling is the driver, as securing proper rest becomes essential for ensuring a safe and pleasant journey.

U.S. Pat. No. 9,867,486 discloses a U-shaped pillow for travelers in upright seats comprising a first pillow having a first pillow body comprising a first arm and a second arm, a second pillow comprising a third arm and a fourth arm, the first and third arms being attached to a first joint, and the second and forth arms being attached to a second joint wherein the first and second pillows can be rotated about the joints and optionally the joints are extendable to allow the relative angle and separation of the pillows to be varied. The support provides a user with myriad options for positioning the pillow and supporting their upper body, particularly during long periods of sitting upright, such as during travel in an aircraft or bus.

U.S. Pat. No. 10,791,856 and U.S. Pat. No. 10,806,279 disclose a support pillow has a pillow-fill unit comprising pillow fill material, a neck support unit comprising an inflatable air bladder and a pillowcase having a first sleeve for receiving the pillow-fill unit and a second sleeve for receiving the cervical or neck support unit. The second sleeve of the pillowcase includes padding on an inner sleeve surface. The inflatable air bladder includes a valve that operates in a first state to allow an input of pressurized air and in a second state to allow an exit of bladder-stored air. Adding air to the inflatable air bladder, in the first state, increases a size of and pressure in the inflatable air bladder. Also, the padding on the inner sleeve surface of the second sleeve is soft, and compressible. One or more foam substrates are added to support the skull above the nape of the neck.

U.S. Pat. No. 10,236,638 discloses a travel pillow comprising a substantially U-shaped body defining a recess adapted to house the neck of a user. The U-shaped body has a rear portion and first and second side portions that define a rear wall and first and second side walls of the recess and define a shoulder-contacting base and an upper surface. The pillow has a first inflatable headrest having a lower part housed in the recess adjacent the first side wall of the recess and a second inflatable headrest having a lower part housed in the recess adjacent the second side wall of the recess. The first and second inflatable headrests are each alterable between a first configuration wherein they are deflated and a second configuration wherein they are inflated such that respective upper parts of the headrests extend upwardly from the recess so as to cover respective ears of a user.

U.S. Pat. No. 10,085,575 discloses a transformable, multi-function, detachable, foldable, two-piece pillow which allows for comfortable and ergonomically correct prone, supine and seated use. It consists of an upper wedged contour pillow and a lower horseshoe pillow that can be used together or separately. The two-piece design allows for flexibility and ease of use. The invention is suitable for various uses such as sunbathing, weightlifting, exercising, traveling, sleeping, and receiving massage. It provides positioning and support while prone on one's stomach and avoids spinal discomfort.

Although several invented pillows aim to alleviate travelers rest, allowing each traveler to adjust a pillow to his personal and comfortable head resting preferences remains an unmet need.

### SUMMARY OF THE INVENTION

The present invention relates generally to personal support devices, and more specifically to a highly configurable and portable apparatus for providing adjustable support for a user's body part, such as their head, neck, or limbs. The invention is designed to provide a universal solution to the unmet need for personalized support in a multitude of environments, such as vehicles (cars, airplanes, buses), offices, and homes.

According to various embodiments of the present disclosure, a personal support apparatus is provided comprising three primary elements: (1) a support member, such as a cushion or pad, configured to comfortably engage a part of a user's body; (2) a surface engagement member configured to removably secure the apparatus to a continuous, non-edge-dependent surface; and (3) an adjustable angular positioning element that interconnects the support member and the surface engagement member.

Advantageously, certain embodiments of the present disclosure are configured to overcome limitations associated with conventional support devices that rely on edge-clamping mechanisms. Many conventional travel accessories mandate the presence of a structural edge, such as the top lip of a seat or a protruding rail, to serve as an anchoring point. This structural prerequisite inherently limits the deployment of such devices to highly specific environments. By contrast, embodiments of the present disclosure utilize a surface engagement member (such as, but not limited to, a vacuum cup or adhesive pad) adapted to affix directly to continuous, planar, or gently curved surfaces-such as a vehicle window, an office wall, or the solid rear shell of a seat.

By freeing the apparatus from edge-clamping requirements and combining this continuous-surface attachment with a user-adjustable angular positioning element, the apparatus may be deployed in a vastly expanded range of environments. As detailed herein, this combination enables a user to select and secure a multitude of customized resting postures.

The various components of the apparatus may be realized in a wide range of embodiments. The support member may be a travel pillow made from materials like memory foam, inflatable bladders, or gel. The surface engagement member may function via suction, vacuum, reusable adhesion, magnetism, or mechanical clamping. The adjustable positioning arm may be telescopic, foldable, a flexible gooseneck, or comprise multiple segments connected by lockable joints. This specification provides a detailed description of these and many other potential embodiments. In some embodiments, the apparatus may further comprise features such as an integrated storage compartment for the positioning arm, a pump for inflation, or a foldable shelf for electronic devices. However, it is a principal object of the present invention to provide the core functionality of an adjustable, surface-mountable support apparatus, and such additional features are to be considered optional enhancements to the core invention. The invention thus provides for simpler, more cost-effective embodiments that omit certain features, such as the integrated storage compartment, while still delivering the primary benefit of customizable support.

### BRIEF DESCRIPTION OF THE DRAWINGS

The accompanying drawings, which are included to provide a further understanding of the invention by way of non-limiting example only, are incorporated in and constitute a part of this specification, illustrate embodiments of the invention and together with the description serve to explain the principles of the invention wherein:

FIG. 1 schematically illustrates an exemplary travel pillow used by a person while resting on an airplane.

FIG. 2A-2B schematically illustrates a rear view of the person in the airplane using the travel pillow in two different position adjusted by the telescopic support mechanism.

FIG. 3A-3B schematically illustrates front and rear view of the exemplary travel pillow comprising a recess configured to store the folded attachment mechanism of the pillow when folded and not in use by the traveler.

FIG. 4A-4B schematically illustrates the exemplary travel pillow, according to an embodiment of the present invention at its open state.

FIG. 5A-5C schematically illustrates front, rear and side views of the exemplary travel pillow, according to an embodiment of the present invention.

FIG. 6A-6C schematically illustrates folded state, front and rear views of the exemplary travel pillow, according to an embodiment of the present invention comprising a bracket at the rear part configure to secure the pillow.

FIG. 7 schematically illustrates the three detachable cushion parts of the travel pillow according to an embodiment of the present.

FIG. 8 schematically illustrates the foldable shelf in the front side of the travel pillow, that accommodates a cellular phone or tablet according to an embodiment of the present.

### DETAILED DESCRIPTION OF THE INVENTION

The following detailed description expands upon the disclosure incorporated by reference to provide a comprehensive overview of the invention's many potential embodiments and to provide clear antecedent basis for the claims that follow.

### I. Introduction and Overview of the Invention

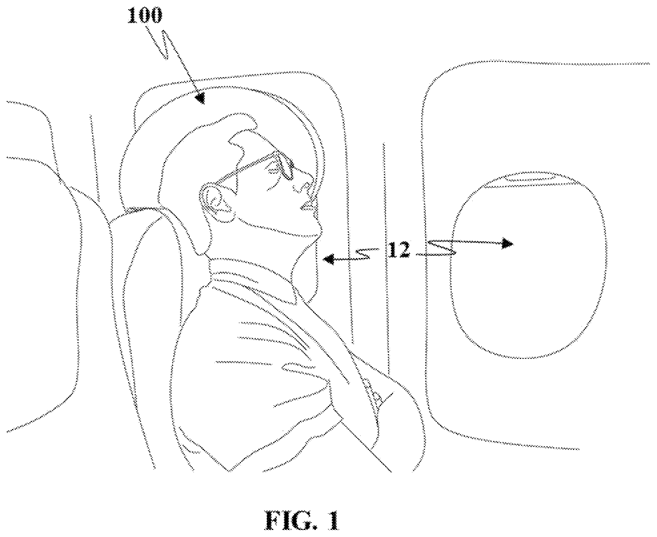

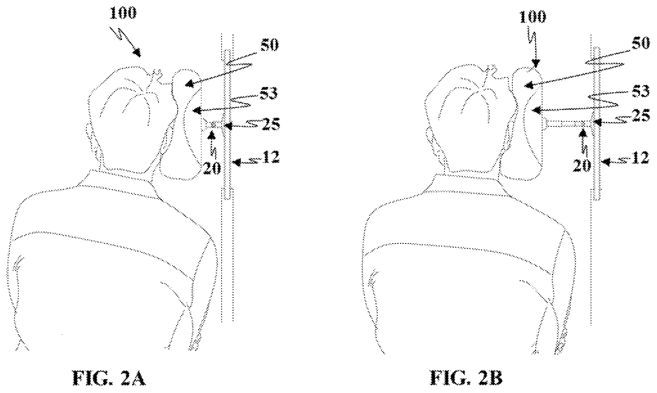

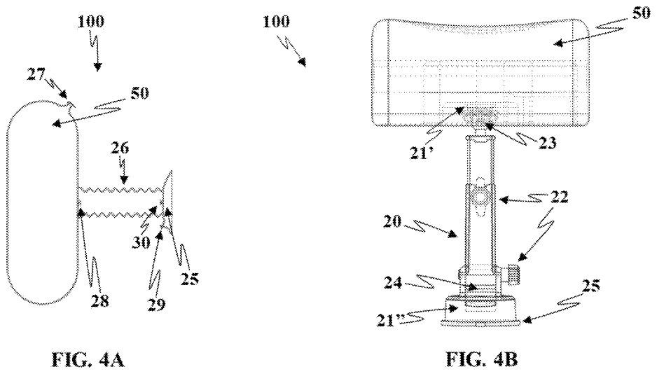

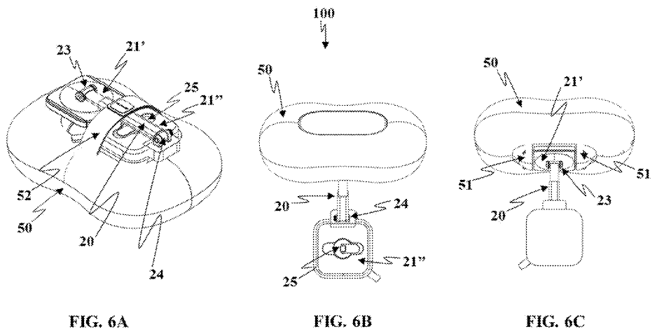

The following detailed description expands upon the disclosures of the parent applications, which are incorporated herein by reference in their entirety, to provide a comprehensive and enabling overview of the invention in its broadest scope. The figures of the parent application, specifically FIGS. 1-8, illustrate certain exemplary, non-limiting embodiments, and it is to be understood that the principles of the present invention are not limited to the specific structures shown therein. The essence of the invention lies in the novel and synergistic combination of a support member, a surface engagement member, and an adjustable linkage assembly. Together, these components create a universally adaptable personal support apparatus designed to provide a user with the ability to achieve a personalized and ergonomic resting or support position in a nearly limitless range of environments and scenarios.

The core of the apparatus is a modular platform comprising three fundamental and cooperative components. The first is a support member designed for direct, comfortable contact with the user's body. The second is a surface engagement member capable of removably and securely affixing the entire apparatus to an external surface. The third, and central to the apparatus's transformative utility, is an adjustable linkage assembly that interconnects the support member and the surface engagement member. This linkage assembly is configurable by the user to precisely control the spatial relationship including the distance, angle, and three-dimensional orientation-between the support member and the point of attachment, thereby granting the user complete control over their comfort.

### II. Synergistic Multi-Environment and Multi-Posture Versatility

While the individual components of the apparatus may be described separately herein, an advantageous aspect of the present disclosure lies in the synergistic combination and functional intersection of two distinct capabilities: (1) the capacity for highly localized, user-defined angular adjustment, and (2) the capacity for edge-independent attachment to a wide variety of continuous or flat surfaces.

Conventional comfort devices and travel pillows frequently suffer from single-mode functionality. Devices that offer some degree of angular adjustability are typically tethered to specific structural requirements, such as clamping mechanisms that mandate the presence of a hard edge, a seatback lip, or a protruding rail. These structural prerequisites severely restrict the user to a singular environment (e.g., an airplane seat) and force the user into a dictated posture. Conversely, conventional devices capable of attaching to flat surfaces (such as basic suction-cup pillows) typically lack dynamic angular adjustability, acting as static abutments that cannot accommodate the varying biomechanical needs of the human neck and spine.

Embodiments of the present disclosure overcome these limitations by uniting continuous-surface engagement with dynamic angular orientation, thereby providing a highly versatile, multi-use personal support apparatus. Because the surface engagement member (e.g., a vacuum cup or adhesive pad) does not rely on a structural edge, the apparatus is adapted to be anchored in a substantially broader array of environments. Simultaneously, because the angular positioning element enables user-defined angular tilt independent of the anchoring surface's geometry, the apparatus accommodates a plurality of distinct resting postures.

This synergistic configuration directly enables multi-posture adaptability. Depending on the environment and the user's immediate anatomical needs, the apparatus may be instantaneously reconfigured to support fundamentally different bodily orientations, including but not limited to:
Forward-leaning postures: A user in an office or a vehicle may affix the surface engagement member to a desk, a folding tray table, or the solid rear shell of a seat. By manipulating the angular positioning element, the support member may be tilted upward to ergonomically receive the user's face or forehead as they lean forward, mitigating the lumbar and cervical strain conventionally associated with forward-resting.
Backward-reclining postures: A user in a high-backed chair, a lounger, or a bathtub may affix the apparatus to a vertical surface directly behind them. The angular positioning element may be adjusted to tilt the support member downward or outward, cradling the occipital region of the head and permitting the cervical musculature to release in a backward-leaning state.
Lateral/sideways postures: A user in a vehicle may affix the apparatus to a side window or adjacent wall. Rather than pressing their head against a static, flat surface, the user may actuate the angular positioning element to tilt the cushion inward toward their head, precisely matching the angle of their neck for optimal lateral support.

The functional combination of these capabilities achieves an effect greater than the sum of the individual parts. By decoupling the location of surface attachment from the angle of bodily support, the disclosed apparatus provides a multi-purpose, multi-environment, and multi-posture solution. The apparatus adapts dynamically to the user, providing customized, ergonomic support across a diverse spectrum of environments and use cases.

### III. The Support Member

### A. Function, Shape, and Size

In various embodiments, the support member can be realized in a multitude of forms, shapes, sizes, and materials, tailored to its intended function. While a primary embodiment is a cushion or travel pillow (50) configured to support a user's head and neck during travel or rest, the support member's design is not so limited. It can be ergonomically contoured to provide targeted lumbar support in an office chair, helping to maintain proper posture during long periods of sitting. It can serve as an arm or wrist support at a desk, elevating the limbs to a neutral position to alleviate strain. It can also be adapted for therapeutic or convalescent use, such as providing elevated support for a leg or foot. The shapes may include, but are not limited to, the U-shape common for travel pillows, as well as rectangular, circular, crescent, or other complex anatomical shapes designed to cradle a specific body part with maximal contact and minimal pressure points. The scale of the support member is fully variable, ranging from a compact, pocket-sized pad suitable for highly portable applications to a full-sized orthopedic cushion designed for extended use.

### B. Materials and Construction

The materials of fabrication for the support member may be selected from any material or combination of materials suitable for providing comfort, support, and durability. Such materials include, for instance, viscoelastic polyurethane foam (commonly known as memory foam), which uniquely conforms to the user's anatomy under pressure and heat, thereby distributing weight evenly. Other embodiments may use resilient latex foam for a more responsive feel, natural down feathers for softness, or synthetic fibers and fills. Further variations include pliable shells filled with microbeads, which can be shifted and shaped by the user for a custom fit. In another key embodiment, the support member may be an inflatable air bladder. This design offers the distinct advantages of a minimal storage volume when deflated and user-adjustable firmness when inflated. Such an inflatable member would include at least one valve (27, 30) for inflation, which could be accomplished by mouth, a manual pump, or an integrated micro-pump, and for controlled deflation. Further still, the member could be a sealed bladder filled with a liquid or a viscous gel, providing unique pressure distribution characteristics and thermal properties, such as retaining heat or cold for therapeutic applications.

### C. Optional and Integrated Features

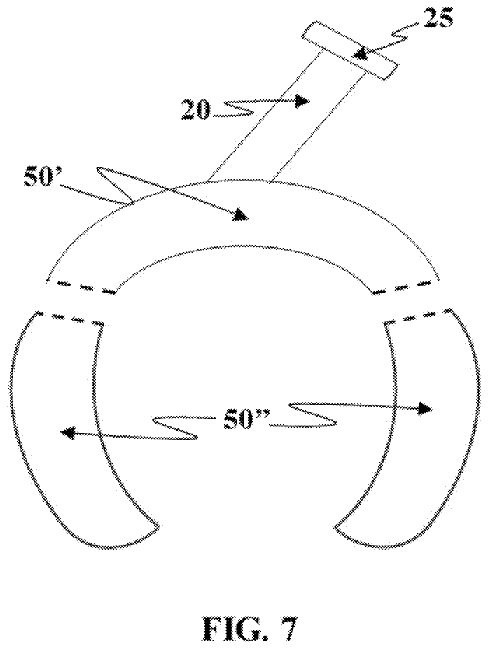

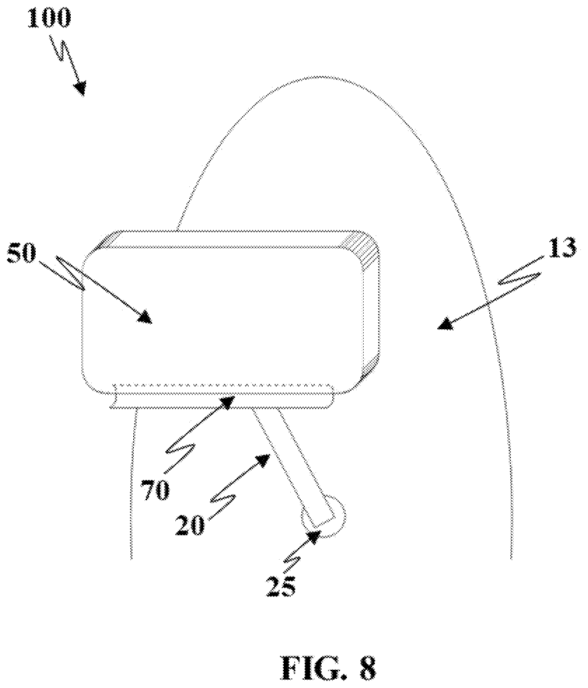

For enhanced utility, the support member may incorporate various integrated or detachable features. As exemplified in FIG. 8, this may include a foldable shelf (70) on its front side, providing a convenient and stable platform for personal electronic devices like smartphones or tablets, allowing for hands-free viewing. In another embodiment, shown in FIG. 7, the support member may be configured in a substantially U-shape comprising three distinct parts: a back part (50′) that is interconnected with the adjustable attachment mechanism, and two neck-surrounding parts (50″) detachably connected to said back part. These neck-surrounding parts (50″) are configured to separate from the back part (50′) and optionally connect to each other, allowing the user to utilize the neck-surrounding parts as a conventional, freestanding travel pillow when no external surface is available for attachment. Other contemplated features include removable and washable fabric covers for hygiene, integrated pockets for storing small items like earphones or charging cables, or even embedded electronic components. These can include miniature speakers for private audio, or active thermal elements for providing heating or cooling, or micro-vibration motors for a massaging effect, thereby adding a therapeutic dimension to the apparatus's function.

### D. Structural Anchoring and Load Distribution

To successfully interface the soft, compliant materials of the support member with the rigid or semi-rigid components of the adjustable angular positioning element, the support member may comprise an integrated load-distributing framework. In embodiments lacking an external bracket or recess (i.e., featureless rear-surface configurations), the support member may comprise an internal rigid or semi-rigid backing plate, skeleton, or mounting flange embedded within or securely affixed to the rear strata of the cushion. This structural anchor serves to dissipate the concentrated mechanical stress and torque generated at the proximal joint across a wider surface area of the cushion material. This prevents tearing, deformation, or mechanical failure of the foam or inflatable bladder when subjected to the eccentric biomechanical loads of a resting human head, ensuring the cushion maintains its structural integrity and ergonomic shape under pressure.

### IV. The Surface Engagement Member

### A. Principles of Operation and Surface Compatibility

The surface engagement member provides the crucial function of removably anchoring the entire apparatus to an external object or surface. The term “smooth surface” as used in the parent disclosure is hereby explicitly expanded to encompass any surface to which a suitable engagement member can affix, including but not limited to surfaces that are smooth, textured, flat, curved, porous, or non-porous. The selection of the engagement member can be tailored to the intended environment of use, ensuring a secure and reliable connection.

Crucially, the ability to engage with a flat or continuous surface (rather than requiring a physical edge, rail, or lip to clamp onto) is a defining advantage of the present invention. This liberates the user from the constraints of specific furniture designs. By relying on surface engagement rather than edge-clamping, the apparatus can be mounted to the center of a window, the middle of a smooth wall, or the continuous rear shell of a modern transport seat, fundamentally expanding the environments in which the apparatus can be deployed and the resulting postural angles the user can adopt.

### B. Exemplary Embodiments

The mechanism of action for this member can vary widely. In one common embodiment, illustrated by the suction cup (25) in the figures, the member operates on the principle of vacuum or suction. To securely anchor the apparatus against the substantial shear forces, cantilevered weight, and dynamic torque generated by a human head leaning on the extended support member, the surface engagement member is engineered for high-capacity load bearing. In vacuum-based embodiments, the surface engagement member may comprise a heavy-duty suction mechanism utilizing an enlarged elastomeric membrane coupled to a mechanical leverage system. For example, a cam-actuated lever mechanism may be utilized to forcibly retract the center of the elastomeric membrane, actively evacuating the cavity to generate an industrial-strength vacuum seal. Alternatively, a manual or electro-pneumatic pump mechanism (e.g., pump 26) comprising a one-way bleed valve may be integrated to allow the user to incrementally extract air from the vacuum cavity until a predetermined secure pressure differential is achieved. To further prevent lateral sliding under load, the peripheral sealing edge of the engagement member may comprise a high-friction, tacky silicone or polyurethane composite designed to resist shear forces on glass or polymer surface. In other embodiments, the member may utilize advanced adhesion. This includes pads made from reusable adhesive materials, such as those employing nano-suction technology or gecko-inspired micro-structures, which can adhere to a wide variety of materials and whose adhesive properties can be refreshed with simple washing. For use with ferromagnetic surfaces, such as metal walls, office cabinets, or certain vehicle bodies, the member can be a powerful magnetic base, for instance one using rare-earth magnets like Neodymium. In yet other embodiments, the engagement member could be a purely mechanical fastener. This includes devices like a spring clamp or a C-clamp configured to affix to the edge of a table, shelf, or headrest, or a system of adjustable straps with buckles for securing the apparatus around an object like a chair post or an overhead bar in a vehicle. It is also contemplated that hybrid members may be used, such as a suction cup having a ring of soft, tacky gel around its perimeter to achieve a superior seal on slightly textured or imperfect surfaces.

### V. The Adjustable Angular Positioning Element

### A. Structural Configurations and Angular Adjustability

The adjustable angular positioning element interconnects the support member and the surface engagement member. It should be understood that the component enabling this adjustment is not limited to an elongated arm or a multi-segment linkage assembly. Rather, the ‘angular positioning element’ may comprise any structural component, joint, or assembly configured to permit angular articulation. For example, in highly compact embodiments, this element may comprise a low-profile ball-and-socket joint, a swivel hinge, or a dynamic articulating node directly coupling the rear of the support member to the surface engagement member, thereby facilitating the requisite angular tilt without necessitating an extended arm structure.

Furthermore, while conventional devices (such as those attempting to improve travel comfort) may permit linear distance adjustment—e.g., via simple telescopic extension an advantageous feature of the present apparatus is its capacity for angular displacement and tilt, independent of, or in addition to, linear extension. The angular positioning element is configured to permit a user to independently alter the angle of the support member relative to the surface engagement member.

By enabling angular articulation, the apparatus accommodates the natural, complex biomechanical curvatures of the human cervical spine, allowing the user to select specific degrees of pitch, yaw, or roll. Although telescopic or linear distance adjustment may be included as an optional, supplementary feature in certain embodiments to further enhance spatial positioning, the multi-posture adaptability of the apparatus is primarily facilitated by this capacity for angular tilt. Thus, the present disclosure provides a robust solution for personalized ergonomic support that is not merely limited to extending or retracting a cushion, but dynamically angling it to meet the user's specific posture.

### B. Locus of Angular Articulation

It is further emphasized that the locus of angular displacement is not restricted to the immediate proximal point of connection between the positioning element and the support member. While a proximal joint (e.g., joint 23) may be utilized, the angular positioning element may alternatively or additionally comprise one or more intermediate articulating joints located distally from the support member along the length of the positioning element. In such configurations, the support member may be rigidly affixed to a proximal segment of the positioning element, and the angular tilt of the support member is achieved by articulating an intermediate ‘elbow’ or ‘mid-span’ joint. Therefore, the spatial orientation of the support member may be modified by actuating joints situated anywhere between the support member and the surface engagement member, providing enhanced kinematic flexibility to navigate around spatial obstacles (such as the protruding curvature of a vehicle seat).

C. Continuous vs. Discrete Angular Adjustment

The angular positioning element is configured to permit the user to select from a plurality of distinct resting postures. This angular adjustability may be achieved through continuous, infinite-resolution mechanisms, or alternatively, through discrete, stepped mechanisms. For example, the joints of the positioning element may utilize continuous-friction locks or ball-and-socket joints that allow positioning at literally any angle within a defined range. Alternatively, to support heavier loads without slipping, the joints may comprise ratcheting mechanisms, interlocking geared teeth (e.g., Hirth joints), or spring-loaded detents. In these discrete configurations, the support member is adjusted between a plurality of pre-defined, indexed angular positions. The present disclosure explicitly encompasses both continuous and discrete angular adjustment modalities, ensuring that the term ‘preferred angle’ or ‘user-selected angle’ denotes any angle achievable by the selected locking mechanism, rather than strictly requiring infinite adjustability.

### D. Joints, Adjustability, and Locking Mechanisms

The user-configurable nature of the assembly is enabled by one or more joints that allow for rotational, angular, or translational displacement. These joints can be located at any point on the assembly. A proximal joint (23) may be located where the assembly connects to the support member, allowing the support member to be tilted or swiveled relative to the linkage. A distal joint (24) may be located where the assembly connects to the surface engagement member, allowing the entire assembly to be positioned relative to the anchor point. Crucially, the assembly may also comprise one or more intermediate joints located anywhere along its length. Such an intermediate joint, functioning akin to a human elbow or wrist, provides critical additional points of articulation. This dramatically increases the range of achievable positions and allows the user to maneuver the support member around obstacles, making the apparatus functional in even the most constrained spaces. The joints themselves may be simple pivot or hinge joints, or they may be multi-axis ball-and-socket joints that permit a much wider range of motion. To ensure stability, these joints are preferably lockable. The locking mechanisms can include any suitable means, such as user-friendly threaded fasteners like wing bolts (22), cam-action levers, friction dials allowing for infinitesimal adjustment, positive-locking push-buttons, or ratcheting detent mechanisms that provide tactile and audible feedback as they click into discrete, secure positions.

### E. Biomechanical Load Bearing and Torsional Rigidity

Unlike conventional articulated mounts designed for lightweight consumer electronics, the angular positioning element of the present disclosure is specifically engineered to resist the substantial torsional and cantilevered loads exerted by a resting human body part. The structural segments of the positioning element may be fabricated from high-tensile materials, such as extruded aluminum alloys, carbon fiber composites, or glass-filled thermoplastics. Furthermore, the lockable joints (whether continuous or discrete) are configured to maintain high static friction or mechanical interference. In discrete locking embodiments, the utilization of interlocking geared teeth (e.g., Hirth couplings) ensures that once a preferred angular tilt is selected and locked, the joint physically cannot slip or collapse under the weight of the user's head. This high torsional rigidity ensures that the multi-posture adaptability of the apparatus is not compromised by mechanical yielding during prolonged periods of rest.

### VI. Alternative Embodiments, System Modularity, and Exemplary Use Cases

### A. Minimalist, Featureless, and Detachable Configurations

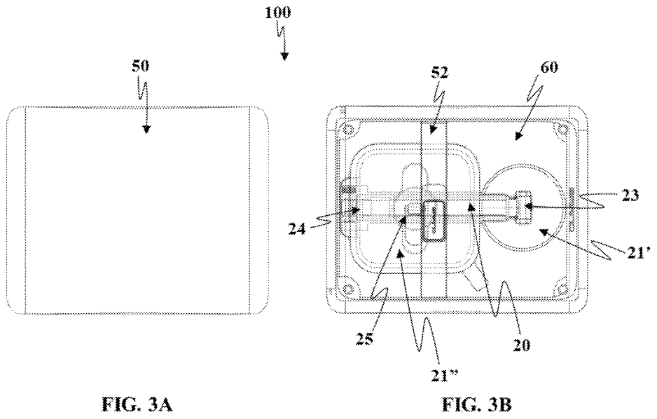

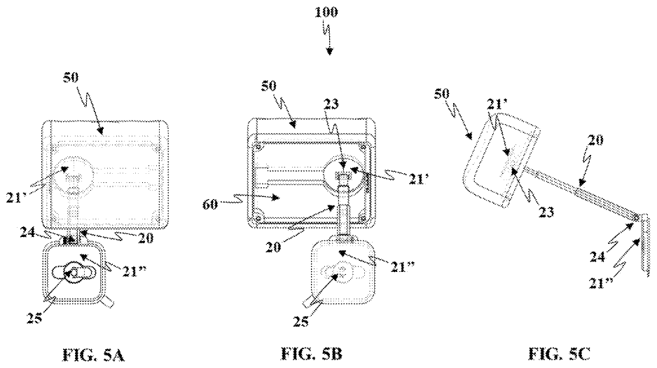

The integration of the core components is intended to be broadly construed. A primary advantageous aspect of the present disclosure is the provision of embodiments that deliberately omit integrated storage compartments, recesses, or brackets. While certain exemplary figures (e.g., FIGS. 3B and 5B) illustrate a recess (60) or bracket (51), it is expressly contemplated that in alternative minimalist configurations, the support member (50) comprises a substantially flush, continuous, or featureless rear surface. In such embodiments, the angular positioning element attaches directly to this featureless rear surface. The structural integrity, stabilization, and deployment of the apparatus do not rely upon, and are completely independent of, any interaction with a storage compartment or securing bracket.

Furthermore, while the positioning element may be described in certain embodiments as ‘foldable’, the present disclosure is not so limited. To facilitate extreme portability and modularity, the angular positioning element may be fully detachable from the support member, the surface engagement member, or both. Rather than folding into a designated compartment on the cushion, the user may completely disconnect the angular positioning element via a quick-release mechanism, threaded collar, or magnetic coupling. The disconnected components may then be stored separately (e.g., in a standalone carrying case, a backpack, or a personal bag). This detachable configuration entirely eliminates the need for an integrated storage volume on the cushion itself, thereby reducing the weight, cost, and manufacturing complexity of the support member.

### B. System Modularity and Kits

In a further embodiment, the apparatus is conceived as a modular system. The connection points between the support member and the linkage assembly, and between the linkage assembly and the surface engagement member, may be standardized. This would allow a user to interchange different components, creating a customizable “kit”. For example, a user could pair a large lumbar support member with a mechanical clamp for office use, and then swap it for a small inflatable pillow and a suction cup for air travel, all while using the same articulated linkage assembly. This modularity dramatically expands the utility and value of the invention.

### C. Exemplary Scenarios of Use

The use cases for this invention are vast. A traveler on an airplane can affix the device to the cabin window or the seatback in front of them, adjusting the support member perfectly to their head for sleep, avoiding neck strain. An office worker can attach it to a cubicle wall or monitor to provide dynamic neck or lumbar support throughout the workday. A person at home could attach it to a tiled wall in a bathtub for a comfortable headrest, or to a headboard for ergonomic support while reading in bed. A mechanic could attach it to the underside of a vehicle to support their head while working. A musician could use it as a custom backrest on a stool, and a person in a wheelchair could use it for supplemental positioning and support. The invention thus provides not merely a product, but a complete and versatile platform for personal comfort and ergonomic support in any situation where a surface is available for anchoring.

### VII. Conclusion and Scope of the Invention

It is to be understood that the foregoing description and the accompanying drawings are for purposes of illustration and description only, and are not intended to be exhaustive or to limit the invention to the particular forms disclosed. The embodiments were chosen and described in order to best explain the principles of the invention and its practical application, thereby enabling others skilled in the art to understand the invention for various embodiments and with various modifications as are suited to the particular use contemplated.

Numerous modifications and variations are possible in light of the above teaching without departing from the broad inventive concepts described herein. For example, any of the three core components-the support member, the adjustable linkage assembly, and the surface engagement member-may be altered in form, function, or material. The support member may vary in materials, dimensions, and ergonomic contours. The adjustable linkage assembly may vary in the number of segments, the type of joints (e.g., friction hinges, magnetic joints), the materials, and the locking mechanisms. The surface engagement member may be realized through any now known or later developed technology for removable affixation, including but not limited to advanced adhesives, electro-adhesion, or novel mechanical clamping designs.

The invention is therefore to be defined not by the specific examples provided, but by the underlying principles they represent. So long as a device comprises a support member configured for user comfort, a surface engagement member for removable attachment, and an adjustable linkage assembly for controlling the spatial relationship between the two, it is considered to fall within the spirit and scope of the present invention. Accordingly, it is not intended that the invention be limited, except as by the spirit and scope of the appended claims and their equivalents.

1. A personal support apparatus, comprising:
a support member configured to engage and support a part of a user's body;
a surface engagement member configured to removably secure the apparatus directly to a smooth, continuous surface without requiring a structural edge; and
an adjustable angular positioning element interconnecting the support member and the surface engagement member;
wherein said adjustable angular positioning element is configured to permit angular displacement and tilt of the support member relative to the surface engagement member, thereby allowing a user to adjust and lock the support member into a plurality of user-selected angles to accommodate different resting postures.

2. The apparatus of claim 1, wherein the support member is a cushion configured to support a user's head.

3. The apparatus of claim 1, wherein the surface engagement member is selected from the group consisting of: a suction cup, a vacuum base, a reusable adhesive pad, and a magnetic base.

4. The apparatus of claim 1, wherein the adjustable angular positioning element comprises at least one lockable joint selected from the group consisting of a pivot joint, a swivel hinge, and a ball-and-socket joint.

5. The apparatus of claim 1, wherein the adjustable angular positioning element further comprises a mechanism for adjusting a linear distance between the support member and the surface engagement member.

6. The apparatus of claim 1, wherein the apparatus does not include an integrated storage compartment for the adjustable angular positioning element, and wherein said positioning element attaches to a substantially featureless rear surface of the support member.

7. The apparatus of claim 1, further comprising an integrated storage compartment on a rear surface of the support member, configured to store the adjustable angular positioning element when not in use.

8. A travel pillow, comprising:
a portable cushion configured to support a user's head; and
an adjustable attachment mechanism interconnected with said cushion, wherein the attachment mechanism comprises a surface engagement member configured to removably attach to a smooth surface of a supporting object;
wherein the attachment mechanism comprises at least one joint configured to permit angular displacement of the cushion relative to the supporting object, enabling a user to position and secure the cushion at a customized angle of tilt; and
further wherein said adjustable attachment mechanism operates independently of any edge-clamping requirement, allowing attachment to a continuous planar or curved surface.

9. The travel pillow of claim 8, further comprising a storage compartment interconnected with said cushion, wherein the storage compartment and the adjustable attachment mechanism are configured to secure the cushion in a deployed state.

10. The travel pillow of claim 8, wherein the adjustable attachment mechanism comprises a multi-segment, articulated linkage.

11. The travel pillow of claim 8, wherein the surface engagement member comprises a vacuum suction cup.

12. The travel pillow of claim 10, wherein the at least one joint includes an intermediate pivot joint located along a length of the multi-segment, articulated linkage between a proximal end and a distal end thereof.

13. The travel pillow of claim 8, wherein the cushion comprises a substantially U-shape including a back part interconnected with the adjustable attachment mechanism, and two neck-surrounding parts detachably connected to said back part, said neck-surrounding parts being configured to separate from the back part to enable the user to utilize the neck-surrounding parts as a freestanding travel pillow.

14. The travel pillow of claim 8, wherein the adjustable attachment mechanism is completely detachable from the cushion via a quick-release coupling, thereby permitting the adjustable attachment mechanism to be removed and stored entirely separately from the cushion.

15. A method for providing a user with personalized, multi-posture support, said method comprising:
providing a support apparatus comprising a portable cushion, a surface engagement member, and an adjustable angular positioning element interconnecting the cushion and the surface engagement member;
securing the support apparatus to a smooth, continuous surface by affixing the surface engagement member thereto; and
angularly displacing the cushion relative to the continuous surface by manipulating the adjustable angular positioning element to adjust a tilt angle of the cushion, thereby allowing the user to select a customized resting posture.

16. The method of claim 15, wherein the step of angularly displacing the cushion comprises actuating and locking a joint located on the adjustable angular positioning element.

17. The method of claim 15, wherein the continuous surface is an airplane window or a solid vehicle seat back, and the step of securing comprises activating a vacuum suction cup to affix the surface engagement member to said continuous surface.

18. The method of claim 15, further comprising the step of adjusting a linear distance between the cushion and the continuous surface by extending or retracting a portion of the adjustable angular positioning element.

19. The apparatus of claim 1, wherein the adjustable angular positioning element comprises a discrete locking mechanism configured to secure the support member in one of a plurality of pre-defined, indexed angular positions.

20. The apparatus of claim 1, wherein the adjustable angular positioning element comprises a proximal segment rigidly affixed to the support member, and an intermediate articulating joint located distally from the support member, wherein the angular displacement and tilt of the support member is achieved by actuating said intermediate articulating joint.
